(19) United States
(12) Patent Application Publication
(10) Pub. No.: US 2026/0054515 A1
(43) Pub. Date: Feb. 26, 2026

(54) AUXILIARY WRITING TOOL

(71) Applicant: Anqi ZHANG, New York, NY (US)

(72) Inventor: Anqi ZHANG, New York, NY (US)

(21) Appl. No.: 19/324,303

(22) Filed: Sep. 10, 2025

(51) Int. Cl. B43K 23/004

(52) U.S. Cl. CPC B43K 23/004

(57) ABSTRACT

An auxiliary writing tool, including a first receiving component, defined with a first channel and a first receiving section, The first channel extends through the first receiving component along its main longitudinal direction and is configured to receive a writing tool. The first receiving section is configured to receive the distal ends of the thumb and index finger. A second receiving component, made of elastic material, and connected to the first receiving component. The second receiving component includes a through-hole, a first abutment portion, and a second placement portion; the first abutment portion is configured to abut against the user's palm; the second placement portion is configured to accommodate the distal ends of the middle finger, ring finger, and little finger. The auxiliary writing tool is comprehensively and comfortably assisted in correcting and supporting proper finger posture for writing, with a broad range of adaptability.

### TECHNICAL FIELD

The present disclosure relates to the technical field of writing tools, in particular to an auxiliary writing tool.

### BACKGROUND OF THE DESCRIPTION

Writing plays a crucial role in daily learning, work, and communication. Whether it's students completing homework, professionals handling documents, or individuals recording daily life, writing is an essential activity.

Many individuals, such as children with autism spectrum disorder (ASD; DSM-5 299.00) or attention-deficit/hyperactivity disorder (ADHD; DSM-5 314.01), persons with upper-limb differences including single-arm amputation, and those with reduced hand strength, experience difficulty in using a pen grip effectively Additionally, during the writing process, due to a lack of stable support or sufficient strength, these groups face greater obstacles when training to grip a pen. This not only increases the difficulty and fatigue of writing but can also reduce writing efficiency and quality.

Currently, there are some tools on the market aimed at assisting with proper writing posture, but these tools have several shortcomings. Some tools have a simple structure that can only provide limited constraint for a few fingers, making it difficult to comprehensively and accurately regulate the correct positioning of the thumb, index finger, middle finger, ring finger, and little finger. These tools struggle to fundamentally correct poor writing posture. Additionally, some tools lack comfort in their design, limiting the movement of the fingers after being worn, thus affecting writing flexibility and making it difficult for users to adapt, leading to abandonment of use. Furthermore, existing tools have a narrow range of applicability and cannot meet the personalized writing needs of people with different ages or hand shapes.

Therefore, the development of an auxiliary writing tool that can comprehensively and comfortably assist in regulating finger posture for writing, with a broad range of applicability, has become an urgent need to address current writing posture issues.

### SUMMARY OF THE DESCRIPTION

To overcome the shortcomings of the prior art, the present disclosure provides an auxiliary writing tool that can comprehensively and comfortably assist in regulating finger posture during writing, with a wide range of adaptability.

An embodiment of the present disclosure provides an auxiliary writing tool. Briefly described, in terms of structure, one embodiment of the device may be implemented as follows.

An auxiliary writing tool, including a first receiving component and a second receiving component. The first receiving component is defined with a first channel and a first receiving section. The first channel is arranged to pass through the first receiving component along a main extension direction of the first receiving component, and the first channel is configured to receive a writing tool. The first receiving section is configured to receive a distal end of a thumb finger and a distal end of an index finger of a user. A material of the second receiving component is an elastic material. The second receiving component is connected to the first receiving component. The second receiving component includes a through hole, a first side, and a second side; the first side is configured to rest against a palm of the user; and the second side is configured to allow distal ends of a middle finger, a ring finger, and a little finger of the user to be grasped.

The present disclosure further provides an auxiliary writing tool, including a first receiving component and a second receiving component. The first receiving component is defined with a first channel and a first receiving section. The first channel is arranged to pass through the first receiving component along a main extension direction of the first receiving component, and the first channel is configured to receive a writing tool. The first receiving section is configured to receive a distal end of a thumb finger and a distal end of an index finger of a user. A material of the second receiving component is an elastic material. The second receiving component is connected to the first receiving component. The second receiving component includes a first abutment part and a second placing part. The second receiving component is annular. The first abutment part is configured to abut against a palm of the user; the second placing part is configured to place a distal end of a middle finger, a distal end of a ring finger, and a distal end of a little finger.

The beneficial effects of the present disclosure are as follows: through the structural configuration described above, the auxiliary writing tool is provided that can comprehensively and comfortably assist in regulating finger posture during writing and is widely adaptable.

### BRIEF DESCRIPTION OF DRAWINGS

To more clearly illustrate the technical solutions in the embodiments of the present disclosure, the drawings required for the description of the embodiments will be briefly introduced below. The drawings described below merely represent some embodiments of the present disclosure. For those skilled in the art, other drawings may also be obtained based on these drawings without any creative effort.

The present disclosure is further described below in conjunction with the drawings and embodiments.

FIG. 1 is a rear, bottom, and right perspective view of an auxiliary writing tool, which is inserted in a writing tool, according to an embodiment of the present disclosure.

FIG. 2 is a front, top, and left perspective view of the auxiliary writing tool, which is inserted in the writing tool, according to an embodiment of the present disclosure.

FIG. 3 is a schematic structural diagram of the auxiliary writing tool according to an embodiment of the present disclosure.

FIG. 4 is a first partial cross-sectional view of the auxiliary writing tool according to an embodiment of the present disclosure.

FIG. 5 is a second partial cross-sectional view of the auxiliary writing tool according to an embodiment of the present disclosure.

FIG. 6 is a third partial cross-sectional view of the auxiliary writing tool according to an embodiment of the present disclosure.

FIG. 7 is a top view of the auxiliary writing tool according to an embodiment of the present disclosure.

FIG. 8 is a left side view of the auxiliary writing tool according to an embodiment of the present disclosure.

FIG. 9 is a schematic diagram showing a usage state of the auxiliary writing tool according to an embodiment of the present disclosure.

### DESCRIPTION OF THE REFERENCE NUMERAL

1 first receiving component, 10 middle convex structure, 11 first channel, 12 first receiving section, 121 first index finger receiving part, 1221 accommodating channel, 122a first opening, 122b second opening, 13 notch, 2 second receiving component, 21 first side, 211 first abutment part, 22 second part, 221 second placing part, 221a first recess, 221b second recess, 221c third recess, 23 through hole, 3 first supporting component, 4 second abutment component, 100 writing tool.

### DETAILED DESCRIPTION OF THE EMBODIMENTS

The subject matter of the present disclosure is introduced with sufficient detail to enable the reader to understand one or more specific embodiments, which belong to the broader inventive concept. This specification outlines and exemplifies the features of these embodiments, but the inventive subject matter is not limited to the embodiments and features specifically described. Based on these descriptions, it is likely that other similar embodiments and features may arise without exceeding the scope of the present disclosure.

In the description of this disclosure, it should be understood that when the terms “center,” “longitudinal,” “transverse,” “length,” “width,” “thickness,” “top,” “bottom,” “front,” “back,” “left,” “right,” “vertical,” “horizontal,” “top,” “bottom,” “inner,” “outer,” “clockwise,” “counterclockwise,” “axial,” “radial,” “circumferential,” etc., are used, they indicate directional or positional relationships based on the orientations or positional relationships shown in the drawings. These terms are used solely for convenience in describing the present disclosure and simplifying the description, and do not imply that the device or component in question must have a specific orientation, or be constructed and operated in a specific orientation. Therefore, they should not be understood as limiting the scope of the present disclosure.

Additionally, if the terms “first,” “second,” etc., appear, these terms are used only for descriptive purposes and should not be understood as indicating relative importance or implying a specific quantity of the indicated technical features. Thus, features labeled with “first,” “second,” etc., may explicitly or implicitly include at least one of the described features. In the description of this disclosure, when the term “plurality” appears, it means at least two, such as two, three, etc., unless otherwise clearly specified.

Unless otherwise specifically defined, when the terms “install,” “connected,” “linked,” “fixed,” etc., are used, they should be broadly interpreted. For example, they can refer to a fixed connection, a detachable connection, or an integral connection; they can refer to a mechanical connection, an electrical connection, or an indirect connection through an intermediate medium. They may also refer to a direct connection or a connection via an intermediary element, or a communication or interaction relationship between two components, unless otherwise explicitly limited. Those skilled in the art can understand the specific meaning of these terms in this disclosure according to the particular context.

In this disclosure, unless otherwise explicitly stated, when a first feature is described as being “on,” “above,” or “below” a second feature, this may mean that the first and second features are in direct contact, or that they are in indirect contact through an intermediary element. Moreover, when the first feature is described as being “above,” “on top of,” or “above” the second feature, this may indicate that the first feature is directly above or obliquely above the second feature, or it may simply indicate that the first feature is at a higher level than the second feature. Similarly, when the first feature is described as being “below,” “beneath,” or “under” the second feature, it may mean that the first feature is directly below or obliquely below the second feature, or it may simply indicate that the first feature is at a lower level than the second feature.

It should be noted that if a component is described as being “fixed to” or “arranged on” another component, it may be directly on the other component or may be an intermediary element. If one component is considered “connected” to another component, it may be directly connected to the other component or may be an intermediary element. The terms “vertical,” “horizontal,” “up,” “down,” “left,” “right,” and similar expressions used in this disclosure are merely for illustrative purposes and do not indicate the only possible implementations.

Unless otherwise defined, all technical and scientific terms used in this specification have the same meaning as commonly understood by those skilled in the art. While similar or equivalent methods, devices, and materials may be used in the implementation or testing of the subject matter disclosed in this specification, representative methods, devices, and materials will be described below.

The term “writing tool” used in this disclosure refers to any element that can be used for writing, such as (but not limited to) pencils, pens, markers, chalk, highlighters, etc.

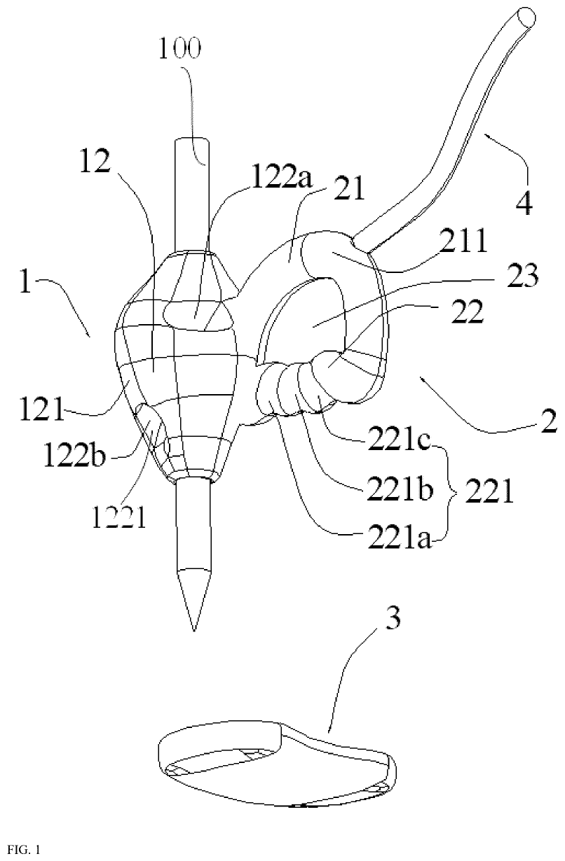

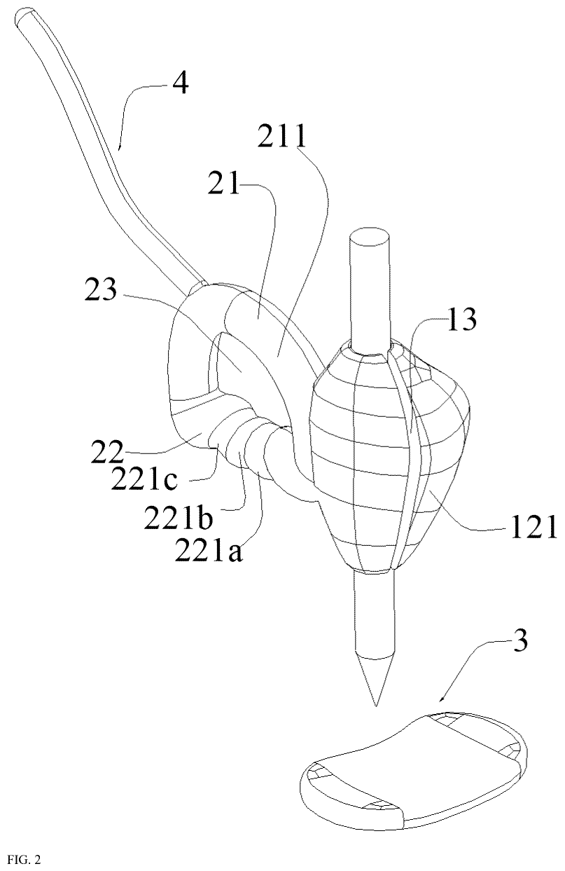

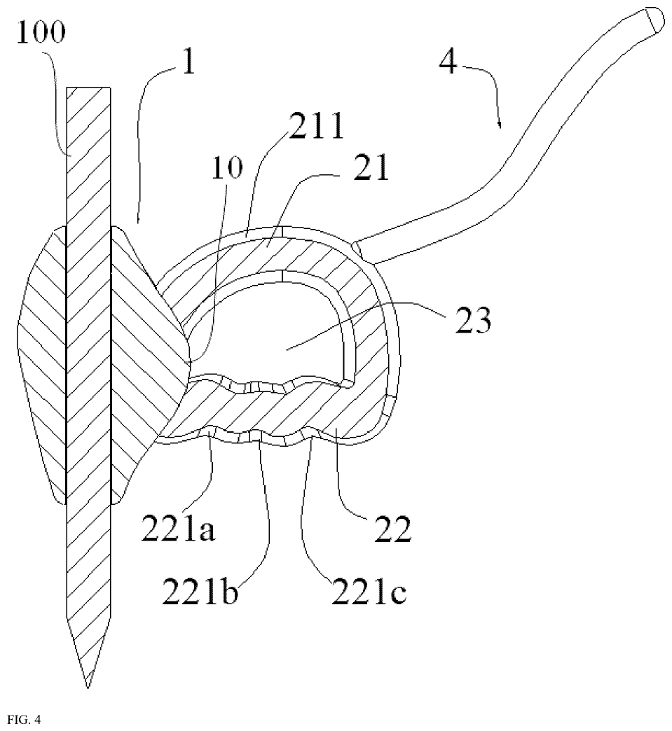

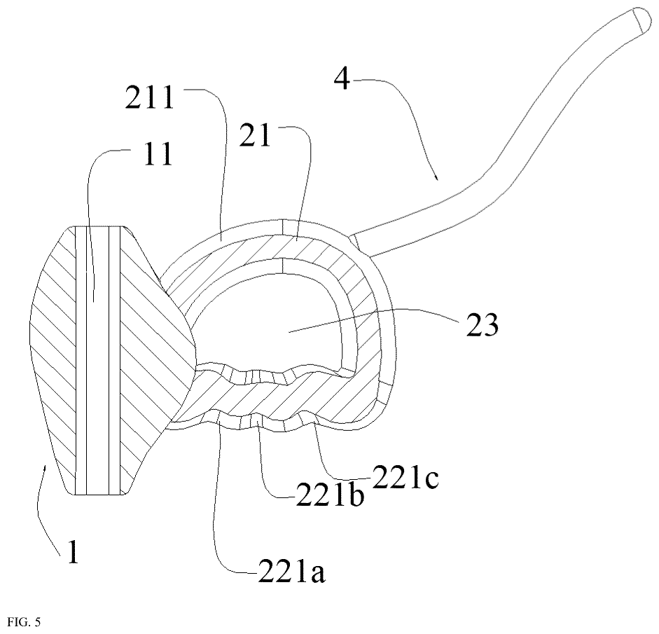

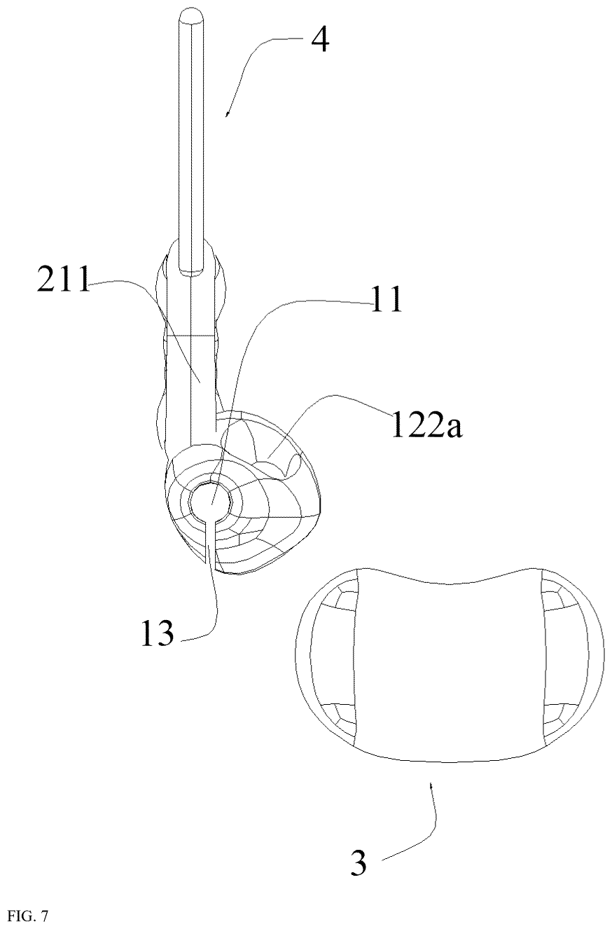

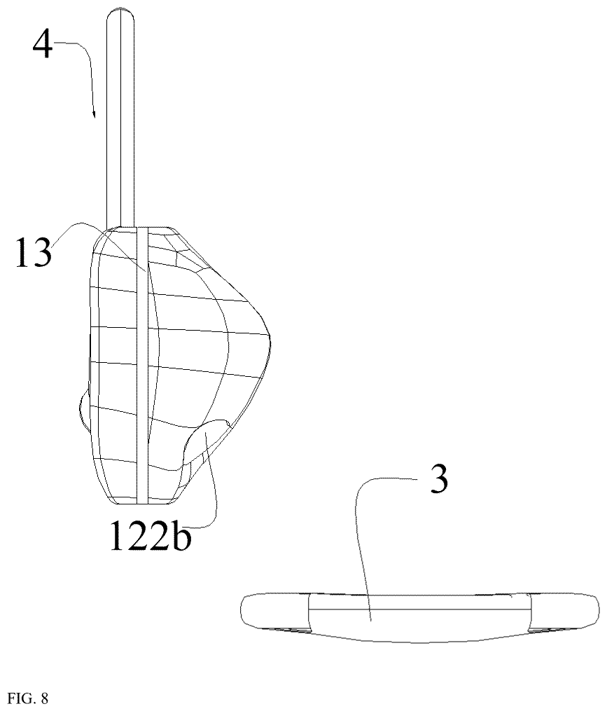

In FIGS. 1 to 9, an auxiliary writing tool is constructed according to the teachings of the present disclosure.

As shown in FIGS. 1, 4, 5, and 9, the auxiliary writing tool includes a first receiving component 1, with a first channel 11 formed on the first receiving component 1. The first channel 11 is arranged to pass through a main extension direction of the first receiving component 1.

This structural arrangement allows the auxiliary writing tool to receive a writing tool 100 through the first channel 11, with the writing tool 100 typically being elongated and axially extending. The first channel 11, extending along the main extension direction of the first receiving component 1, is highly compatible with the natural form of the writing tool 100, guiding the writing tool 100 smoothly in and out, reducing sticking or obstruction caused by misalignment, and allowing the user to quickly place and retrieve the tool. This facilitates the user's ability to easily and quickly insert the writing tool 100 directly into the first channel 11, achieving an engagement of the auxiliary writing tool with the writing tool 100.

It should be understood that the main extension direction of the first receiving component 1 typically refers to a length direction of the first receiving component 1. More specifically, for the writing tool 100, the main extension direction of the first receiving component 1 generally refers to a direction from a writing end of the writing tool 100 to an opposite end (tail) when the writing tool 100 is inserted into the first channel 11. It should be clarified that the first receiving component 1 is generally designed to extend along its main extension direction, although it may also extend partially along its width direction.

Optionally, the first receiving component 1 is made of an elastic material. Most commonly used writing tools today typically have relatively standardized lengths and widths. By manufacturing the first receiving component 1 with an elastic material and designing the diameter of the first channel 11 to be slightly smaller than the standard size of typical writing tools, when a user inserts the writing tool 100 into the first channel 11, an inner wall of the first channel 11 deforms elastically due to compression from the writing tool 100, forming an interference fit. This means the first channel 11 applies continuous encircling pressure on the surface of the writing tool 100. The continuous encircling pressure transforms into static friction, effectively counteracting any displacement caused by hand force or shaking during writing, thereby preventing the writing tool 100 from loosening or slipping within the channel. Compared with rigid channels that rely on precise dimensional matching, the deformation compensation ability of elastic material can accommodate dimensional variations due to manufacturing tolerances (such as slight differences in barrel diameters among different pen brands), ensuring stable constraint for various standardized writing tools. Moreover, the flexibility of elastic material provides gentle contact with the writing tool 100, avoiding hard friction or impacts between rigid channels and tool surfaces. For instance, for a wooden pencil shaft, a metal-coated fountain pen, or a plastic casing, an elastic channel can reduce scratching or damage during insertion/removal and absorb minor vibrations transmitted from the hand during writing, thereby reducing wear caused by long-term use.

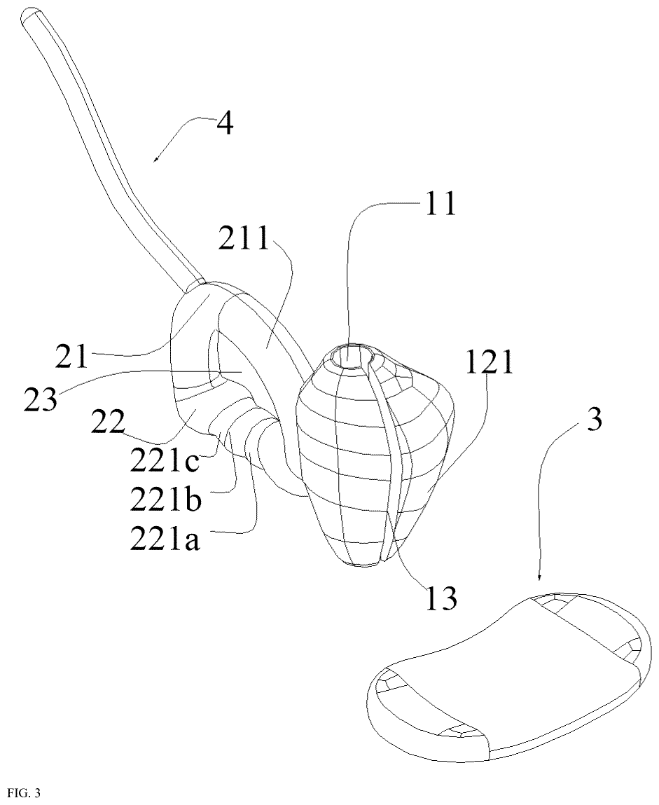

As shown in FIGS. 3, 6, and 7, by defining a notch 13 on the first receiving component 1 and allowing the notch 13 to communicate with the first channel 11, the ends of the notch 13—owing to the elasticity of the material—can relatively open and close. Thus, when the user wants to insert the writing tool 100 into the first channel 11, they can gently pull apart the walls at both ends of the notch 13 through the material's flexibility, temporarily expanding the first channel 11 at the notch 13 to create an entry point. The user can then directly snap the writing tool 100 into the channel from the radial direction, and once released, the walls of the notch 13 will elastically return to position and tighten, wrapping around and securing the writing tool 100 together with the inner wall of the first channel 11. This operation eliminates the need to align the tool precisely with the ends of the first channel 11 and is especially user-friendly for children or individuals with limited hand mobility.

As shown in FIGS. 1 to 8, the first receiving component 1 is equipped with a first receiving section 12, configured to accommodate distal ends of thumb and index finger of the user. The first receiving section 12 includes a first index finger receiving part 121 and a first thumb receiving part 122. The first index finger receiving part 121 and/or the first thumb receiving part 122 may be include one of a receiving cavity, accommodating channel, depression, finger sleeve, or a smoothly contoured surface adapted to the distal fingertip surfaces of the thumb and/or index finger. The first index finger receiving part 121 is configured to receive the distal end of the index finger of the user, while the first thumb receiving part 122 is configured to receive the distal end of the thumb.

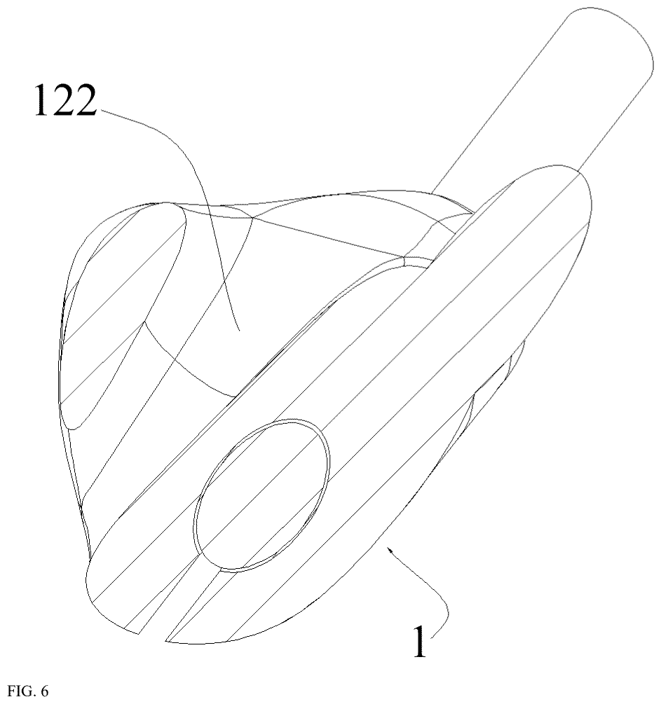

As shown in FIGS. 1 and 6, the first thumb receiving part 122 includes an accommodating channel 1221 that includes a first opening 122a. This first opening 122a allows the thumb of the user to be inserted into the accommodating channel 1221. Fixing the distal end of the thumb in place via the accommodating channel 1221 can effectively help the user maintain a correct writing posture and foster good writing habits.

Optionally, the accommodating channel 1221 includes a second opening 122b, whose shape and size correspond to a tip of the thumb. This second opening 122b allows the thumb to partially pass through and tapers gradually from the first opening 122a to the second opening 122b.

When the user uses the auxiliary writing tool described in this embodiment, the second opening 122b helps ensure proper airflow within the accommodating channel 1221, avoiding discomfort like stuffiness or sweating during prolonged use. Furthermore, by defining the second opening 122b to match the thumb tip size (and adjusting it for different model sizes of the tool), it prevents the thumb from slipping out while also limiting its movement range within the channel. This prevents accidental dislodgement due to force or movement during writing, ensuring the thumb remains in the intended position.

In this example, as shown in FIGS. 1 to 3, the first receiving component 1 features a continuous middle convex structure 10 along its main extension direction. The first index finger receiving part 121 is located on this protruding section. When a user uses the auxiliary writing tool, the fingertip pad of the index finger primarily contacts the first index finger receiving part 121, specifically on the side of the middle convex structure 10 facing the writing end of the writing tool 100. During proper writing posture, the index finger's tip usually adopts a naturally curved “hooked” position, gently pressing the upper side of the pen shaft with slightly bent joints for a stable point of force disclosure. The middle convex structure 10 provides structural support for this posture: the continuous curved surface matches the fingertip contour, and when the finger rests on the side of the middle convex structure 10 facing the writing end, the curvature of the middle convex structure 10 naturally guides the finger into a slightly inward-curved angle, preventing deformities caused by stiffness or overextension. This design serves as a predefined support point for the index finger, reducing the burden of active posture adjustment and making the hooked grip more effortless and sustainable.

Optionally, the first receiving component 1 also presents a continuous middle convex structure 10 along the side near the first thumb receiving part 122.

Optionally, the first opening 122a is positioned near the first index finger receiving part 121 to further assist the user in adopting the correct writing posture.

In a proper writing posture, the distal ends of the thumb and index finger should be “close but not crossed,” with the thumb below the pen and the index finger above, applying appropriate pressure to stabilize the tool. When the first opening 122a is adjacent to the first index finger receiving part 121 (the middle convex structure area), inserting the thumb into the accommodating channel 1221 naturally aligns it at an appropriate angle relative to the index finger, avoiding a loose grip due to excessive distance or finger crowding due to insufficient space.

As shown in FIGS. 1 to 9, the auxiliary writing tool in this example also includes a second receiving component 2, which is connected to the first receiving component 1. The second receiving component 2 includes a first side 21 and a second side 22.

The first side 21 refers to the side of the second receiving component 2 that faces away from the writing end of the writing tool 100 when the user is using the auxiliary writing tool. The second side 22 refers to the side of the second receiving component 2 that is closer to the writing end of the writing tool 100.

During use, the part of the first side 21 that primarily contacts the user's palm is the first abutment part 211. Since the palm naturally forms an arc shape when gripping a pen, the first side 21 typically has a curved structure. When the hand is naturally holding the pen, the palm curves inward due to the bending of the fingers, and the palm muscles are in a mildly contracted state. The first side 21 adopts a curved structure, with the main contact area being the first abutment part 211, which fits the arc-shaped contour of the palm. The curvature of the arc can be designed according to the average size of adult or child palms. When the user grips the pen, the first abutment part 211 can evenly cover the pressure-bearing area of the palm, distributing the pressure over a larger area to avoid localized pressure causing discomfort in the palm.

Of course, in other embodiments, the first side 21 can be of a straight-line or other shapes, and the first abutment part 211 can also be a separate component attached to the first side 21.

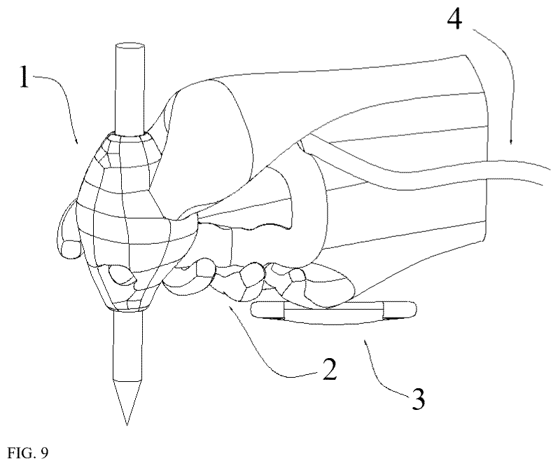

As shown in FIGS. 1 and 9, when using the auxiliary writing tool, the distal ends of the middle finger, ring finger, and little finger are placed on the second side 22. Therefore, the second side 22 has a second placing part 221 corresponding to the distal ends of the middle finger, ring finger, and little finger. The second placing part 221 includes a first recess 221a, a second recess 221b, and a third recess 221c. The first recess 221a is designed to accommodate the distal end of the user's middle finger, the second recess 221b is designed to accommodate the distal end of the user's ring finger, and the third recess 221c is designed to accommodate the distal end of the user's little finger.

In other embodiments, the second placing part 221 can also be a separate component attached to the second placing part 221.

The material of the second receiving component 2 is an elastic material. As shown in FIGS. 1 to 8, in this embodiment, the second receiving component 2 has a ring-shaped structure. The first side 21 is located on the side of the ring structure facing away from the writing end of the writing tool 100, while the second side 22 is located on the side of the ring structure closer to the writing end of the writing tool 100. The first recess 221a, the second recess 221b, and the third recess 221c are all annular depressions, distributed continuously along the second side 22. The second receiving component 2 is designed as a ring structure allows it to deform more effectively with the user's grip. This ensures that the first abutment part 211, which primarily contacts the user's palm, fits better with the palm, providing improved support. The first recess 221a, second recess 221b, and third recess 221c are all annular depressions and are continuously distributed along the second side 22. This structure accommodates the natural contours of the palm and allows the user to select the most comfortable position for placing their fingers based on their finger lengths. This flexibility eliminates the need to adjust the grip due to size mismatches, enhancing the user's experience. For example, children typically have shorter and thinner fingers, while adults have longer and thicker fingers. Even the same user may experience different growth ratios for different fingers. The continuous annular depressions allow the user to choose a comfortable position along the annular path according to their finger characteristics. Shorter fingers can opt for the region closer to the first receiving component 1, while longer fingers can choose a more distant area, without the need to adjust their grip due to size mismatches. This adaptive feature makes the auxiliary writing tool suitable for a wider range of users and significantly enhances the product's versatility.

It should be understood that the ring structure for the second receiving component 2 means that it can form a continuous closed loop by itself and connect to the first receiving component 1, or it can be connected to the first receiving component 1 to form a closed ring structure together.

It should also be understood that the hollow part in the middle of the ring structure (i.e., the through hole 23) can have its dimensions adjusted according to the actual user group and scenario. It only needs to provide space for deformation when the structure deforms elastically.

As shown in FIG. 1, the auxiliary writing tool also includes a first supporting component 3. The first supporting component 3 is configured to support the user's palm on the side closer to the little finger. Specifically, in this example, the first supporting component 3 is not connected to the first receiving component 1 or the second receiving component 2, and the first supporting component 3 is made of an elastic material. This design allows the user to adjust the position of the first supporting component 3 as needed, and the elastic material provides better support for the user. Additionally, the first supporting component 3 can be used independently of the auxiliary writing tool, to assist children with autism in grip training or fist-closing exercises, providing wrist protection and helping with strength and balance training.

In other embodiments, the first supporting component 3 may also be connected to the first receiving component 1 or the second receiving component 2. This would only limit the range within which the user can adjust the first supporting component 3, but it would still be usable. Furthermore, the first supporting component 3 could be made of a rigid material, with the part that contacts the user's palm near the little finger made of an elastic material, and the part that contacts the supporting surface made of a rigid material.

As shown in FIG. 1, the auxiliary writing tool also includes a second abutment component 4. The second abutment component 4 is configured to contact the user's wrist. The second abutment component 4 is connected to the side of the first side 21 that is far from the first receiving component 1, and the second abutment component 4 has an overall S-shape. By allowing the second abutment component 4 to contact the user's wrist, it can effectively prevent the user's wrist from bending backward, helping maintain a proper vertical wrist posture. More specifically, in this example, the second abutment component 4 is detachably connected to the second receiving component 2. The detachable connection allows the user to choose whether or not to use the second abutment component 4 based on their actual needs.

The above describes one or more embodiments provided in conjunction with specific content, and it should not be considered that the specific implementations of this disclosure are limited to these descriptions. Any methods, structures, or technical adaptations that are similar or equivalent to the disclosed concepts, or that are derived from the ideas in this disclosure, should be regarded as falling within the scope of protection of this disclosure.

1. An auxiliary writing tool, comprising:
a first receiving component, which is defined with a first channel and a first receiving section;
wherein the first channel is arranged to pass through the first receiving component along a main extension direction of the first receiving component, and the first channel is configured to receive a writing tool; the first receiving section is configured to receive a distal end of a thumb finger and a distal end of an index finger of a user; and
a second receiving component, a material of the second receiving component is an elastic material; the second receiving component is connected to the first receiving component; wherein the second receiving component comprises a through hole, a first side, and a second side;
wherein the first side is configured to rest against a palm of the user; and
the second side is configured to allow distal ends of a middle finger, a ring finger, and a little finger of the user to be grasped.

2. The auxiliary writing tool according to claim 1, wherein a material of the first receiving component is the elastic material, and the first receiving component is defined with a notch, the notch is communicated with the first channel.

3. The auxiliary writing tool according to claim 1, wherein the second receiving component is an annular structure, and the through hole is a hollow part of the annular structure.

4. The auxiliary writing tool according to claim 1, wherein the first receiving section comprises a first index finger receiving part and a first thumb receiving part, wherein the first index finger receiving part is configured to receive the distal end of the index finger, and the first thumb receiving part is configured to receive the distal end of the thumb.

5. The auxiliary writing tool according to claim 4, wherein the first thumb receiving part comprises an accommodating channel, and the accommodating channel comprises a first opening, wherein the first opening is configured to allow the distal end of the thumb to be inserted into the accommodating channel from the first opening.

6. The auxiliary writing tool according to claim 5, wherein the accommodating channel comprises a second opening, wherein a shape and a size of the second opening correspond to the distal end of the thumb, and the second opening is configured to allow the distal end of the thumb to pass through.

7. The auxiliary writing tool according to claim 5, wherein the first receiving component presents a continuously changing middle convex structure along its main extension direction, wherein the first index finger receiving part is located on the middle convex structure of the first receiving component, and the first opening is set close to the first index finger receiving part.

8. The auxiliary writing tool according to claim 1, wherein the auxiliary writing tool further comprises a first supporting component, which is configured to support a side of the palm near the little finger.

9. The auxiliary writing tool according to claim 1, wherein the auxiliary writing tool further comprises a second abutment component, wherein the second abutment component is in a S-shaped; and the second abutment component is connected to a side of the first side, away from the first receiving component, and is configured to abut against.

10. The auxiliary writing tool according to claim 1, wherein the first side is arcuate and the second side is wavy.

11. An auxiliary writing tool, comprising:
a first receiving component, which is defined with a first channel and a first receiving section;
wherein the first channel is arranged to pass through the first receiving component along a main extension direction of the first receiving component, and the first channel is configured to receive a writing tool; the first receiving section is configured to receive a distal end of a thumb finger and a distal end of an index finger of a user;
a second receiving component, a material of the second receiving component is an elastic material; the second receiving component is connected to the first receiving component; wherein the second receiving component comprises a first abutment part and a second placing part;
wherein the second receiving component is annular;
the first abutment part is configured to abut against a palm of the user;
the second placing part is configured to place a distal end of a middle finger, a distal end of a ring finger, and a distal end of a little finger.

12. The auxiliary writing tool according to claim 11, wherein the second receiving component comprises a first side and a second side, wherein the first abutment part is located on the first side; and
the second placing part comprises a first recess, a second recess, and a third recess, wherein the first recess is configured to place the distal end of the middle finger, the second recess is configured to place the distal end of the ring finger, and the third recess is configured to place the distal end of the little finger;
the first recess, the second recess, and the third recess are distributed on the second side.

13. The auxiliary writing tool according to claim 12, wherein the first recess, the second recess, and the third recess are annular recesses.

14. The auxiliary writing tool according to claim 11, wherein the first receiving section comprises a first index finger receiving part and a first thumb receiving part;
wherein the first index finger receiving part is configured to receive the distal end of the index finger, and the first thumb receiving part is configured to receive the distal end of the thumb.

15. The auxiliary writing tool according to claim 14, wherein the first thumb receiving part comprises an accommodating channel, and the accommodating channel comprises a first opening, wherein the first opening is configured to allow the distal end of the thumb to be inserted into the accommodating channel from the first opening.

16. The auxiliary writing tool according to claim 15, wherein the accommodating channel comprises a second opening, wherein a shape and a size of the second opening correspond to the distal end of the thumb, and the second opening is configured to allow the distal end of the thumb to pass through.

17. The auxiliary writing tool according to claim 15, wherein the first receiving component presents a continuously changing middle convex structure along its main extension direction, wherein the first index finger receiving part is located on the middle convex structure of the first receiving component, and the first opening is set close to the first index finger receiving part.

18. The auxiliary writing tool according to claim 11, wherein a material of the first receiving is an elastic material, and the first receiving component is defined with a notch, the notch is communicated with the first channel.

19. The auxiliary writing tool according to claim 11, wherein the auxiliary writing tool further comprises a first supporting component, which is configured to support a side of the palm near the little finger.

20. The auxiliary writing tool according to claim 11, wherein the auxiliary writing tool further comprises a second abutment component, wherein the second abutment component is in a S-shaped, and the second abutment component is connected to a side of the first side, away from the first receiving component, and is configured to abut against a wrist of the user.
